(19) United States
(12) Patent Application Publication
(10) Pub. No.: US 2025/0226956 A1
(43) Pub. Date: Jul. 10, 2025

(54) SEMI-KNOWN TRANSMISSION CONFIGURATION INDICATOR STATE

(71) Applicant: QUALCOMM Incorporated, San Diego, CA (US)

(72) Inventors: Qiaoyu LI, Beijing (CN); Changhwan PARK, San Diego, CA (US); Tao LUO, San Diego, CA (US); Mahmoud TAHERZADEH BOROUJENI, San Diego, CA (US); Hamed PEZESHKI, San Diego, CA (US); Taesang YOO, San Diego, CA (US); Arumugam CHENDAMARAI KANNAN, San Diego, CA (US); Tianyang BAI, Mountain View, CA (US)

(21) Appl. No.: 18/853,215

(22) PCT Filed: May 27, 2022
(86) PCT No.: PCT/CN2022/095602

§ 371 Date: Oct. 1, 2024

(51) Int. Cl. H04L 5/00; H04W 72/21; H04W 72/231

(52) U.S. Cl. CPC H04L 5/0053; H04L 5/0051; H04W 72/21; H04W 72/231

(57) ABSTRACT

Various aspects of the present disclosure generally relate to wireless communication. In some aspects, a user equipment (UE) may identify a transmission configuration indicator (TCI) state. The UE may determine that the TCI state is a semi-known TCI-state based at least in part on a known TCI state condition not being satisfied and a TCI state prediction condition being satisfied. The UE may apply a TCI state switching delay timeline that is associated with semi-known TCI states. Numerous other aspects are described.

### FIELD OF THE DISCLOSURE

Aspects of the present disclosure generally relate to wireless communication and to techniques and apparatuses for using semi-known transmission configuration indicator states.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include identifying a transmission configuration indicator (TCI) state. The method may include determining that the TCI state is a semi-known TCI-state based at least in part on a known TCI state condition not being satisfied and a TCI state prediction condition being satisfied. The method may include applying a TCI state switching delay timeline that is associated with semi-known TCI states.

Some aspects described herein relate to a method of wireless communication performed by a UE. The method may include identifying a TCI state. The method may include determining that a known TCI state condition is not satisfied and a TCI state prediction condition is satisfied. The method may include applying a TCI state switching delay timeline that is associated with known TCI states.

Some aspects described herein relate to a method of wireless communication performed by a network entity. The method may include receiving a preference indication that indicates a preference associated with determining whether a TCI state is semi-known. The method may include transmitting a configuration that includes a capability for determining whether a TCI state is a semi-known TCI state.

Some aspects described herein relate to a UE for wireless communication. The UE may include a memory and one or more processors coupled to the memory. The one or more processors may be configured to identify a TCI state. The one or more processors may be configured to determine that the TCI state is a semi-known TCI-state based at least in part on a known TCI state condition not being satisfied and a TCI state prediction condition being satisfied. The one or more processors may be configured to apply a TCI state switching delay timeline that is associated with semi-known TCI states.

Some aspects described herein relate to a UE for wireless communication. The UE may include a memory and one or more processors coupled to the memory. The one or more processors may be configured to identify a TCI state. The one or more processors may be configured to determine that a known TCI state condition is not satisfied and a TCI state prediction condition is satisfied. The one or more processors may be configured to apply a TCI state switching delay timeline that is associated with known TCI states.

Some aspects described herein relate to a network entity for wireless communication. The network entity may include a memory and one or more processors coupled to the memory. The one or more processors may be configured to receive a preference indication that indicates a preference associated with determining whether a TCI state is semi-known. The one or more processors may be configured to transmit a configuration that includes a capability for determining whether a TCI state is a semi-known TCI state.

Some aspects described herein relate to a non-transitory computer-readable medium that stores a set of instructions for wireless communication by a UE. The set of instructions, when executed by one or more processors of the UE, may cause the UE to identify a TCI state. The set of instructions, when executed by one or more processors of the UE, may cause the UE to determine that the TCI state is a semi-known TCI-state based at least in part on a known TCI state condition not being satisfied and a TCI state prediction condition being satisfied. The set of instructions, when executed by one or more processors of the UE, may cause the UE to apply a TCI state switching delay timeline that is associated with semi-known TCI states.

Some aspects described herein relate to a non-transitory computer-readable medium that stores a set of instructions for wireless communication by a UE. The set of instructions, when executed by one or more processors of the UE, may cause the UE to identify a TCI state. The set of instructions, when executed by one or more processors of the UE, may cause the UE to determine that a known TCI state condition is not satisfied and a TCI state prediction condition is satisfied. The set of instructions, when executed by one or more processors of the UE, may cause the UE to apply a TCI state switching delay timeline that is associated with known TCI states.

Some aspects described herein relate to a non-transitory computer-readable medium that stores a set of instructions for wireless communication by a network entity. The set of instructions, when executed by one or more processors of the network entity, may cause the network entity to receive a preference indication that indicates a preference associated with determining whether a TCI state is semi-known. The set of instructions, when executed by one or more processors of the network entity, may cause the network entity to transmit a configuration that includes a capability for determining whether a TCI state is a semi-known TCI state.

Some aspects described herein relate to an apparatus for wireless communication. The apparatus may include means for identifying a TCI state. The apparatus may include means for determining that the TCI state is a semi-known TCI-state based at least in part on a known TCI state condition not being satisfied and a TCI state prediction condition being satisfied. The apparatus may include means for applying a TCI state switching delay timeline that is associated with semi-known TCI states.

Some aspects described herein relate to an apparatus for wireless communication. The apparatus may include means for identifying a TCI state. The apparatus may include means for determining that a known TCI state condition is not satisfied and a TCI state prediction condition is satisfied. The apparatus may include means for applying a TCI state switching delay timeline that is associated with known TCI states.

Some aspects described herein relate to an apparatus for wireless communication. The apparatus may include means for receiving a preference indication that indicates a preference associated with determining whether a TCI state is semi-known. The apparatus may include means for transmitting a configuration that includes a capability for determining whether a TCI state is a semi-known TCI state.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of using beams for communications between a network entity and a UE, in accordance with the present disclosure.

FIG. 5 is a diagram illustrating an example of beam prediction, in accordance with the present disclosure.

FIG. 6 is a diagram illustrating an example of a known transmission configuration indicator (TCI) state, in accordance with the present disclosure.

FIG. 7 is a diagram illustrating examples of TCI state switching timelines, in accordance with the present disclosure.

FIG. 8 is a diagram illustrating an example of predicting channel characteristics, in accordance with the present disclosure.

FIG. 9 is a diagram illustrating an example of using a semi-known TCI state, in accordance with the present disclosure.

FIG. 10 is a diagram illustrating examples of TCI state switching timelines for semi-known TCI states, in accordance with the present disclosure.

FIG. 11 is a diagram illustrating an example process performed, for example, by a UE, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIGS. 14-15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

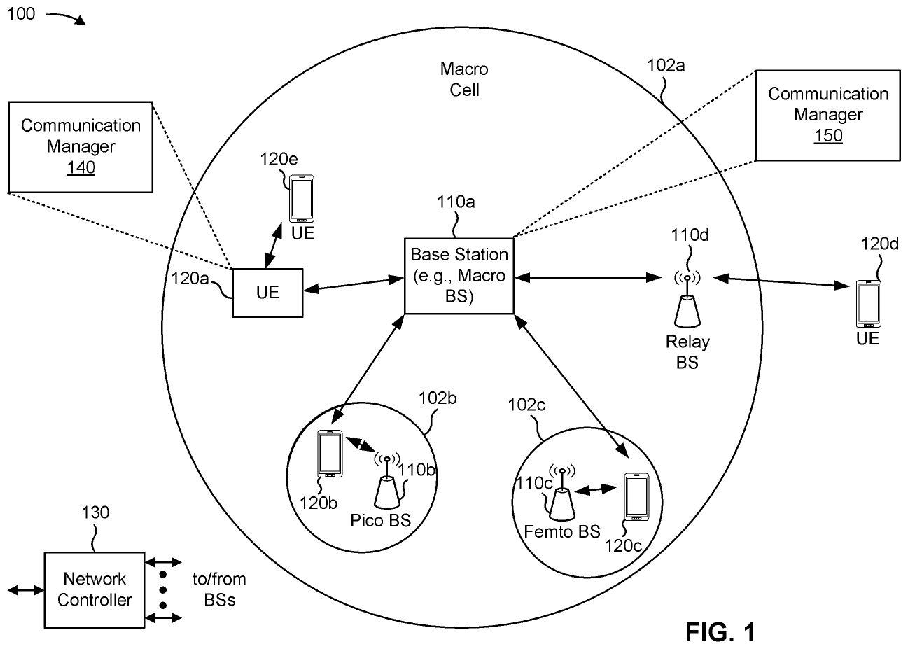

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify a transmission configuration indicator (TCI) state and determine that the TCI state is a semi-known TCI-state based at least in part on a known TCI state condition not being satisfied and a TCI state prediction condition being satisfied. The communication manager 140 may apply a TCI state switching delay timeline that is associated with semi-known TCI states.

In some aspects, the communication manager 140 may identify a TCI state and determine that a known TCI state condition is not satisfied, and a TCI state prediction condition is satisfied. The communication manager 140 may apply a TCI state switching delay timeline that is associated with known TCI states. Additionally, or alternatively, the communication manager 140 may perform one or more other operations described herein.

In some aspects, a network entity (e.g., a base station 110) may include a communication manager 150. As described in more detail elsewhere herein, the communication manager 150 may receive a preference indication that indicates a preference associated with determining whether a TCI state is semi-known. The communication manager 150 may transmit a configuration that includes a capability for determining whether a TCI state is a semi-known TCI state. Additionally, or alternatively, the communication manager 150 may perform one or more other operations described herein.

As indicated above, FIG. 1 is provided as an example. Other examples may differ from what is described with regard to FIG. 1.

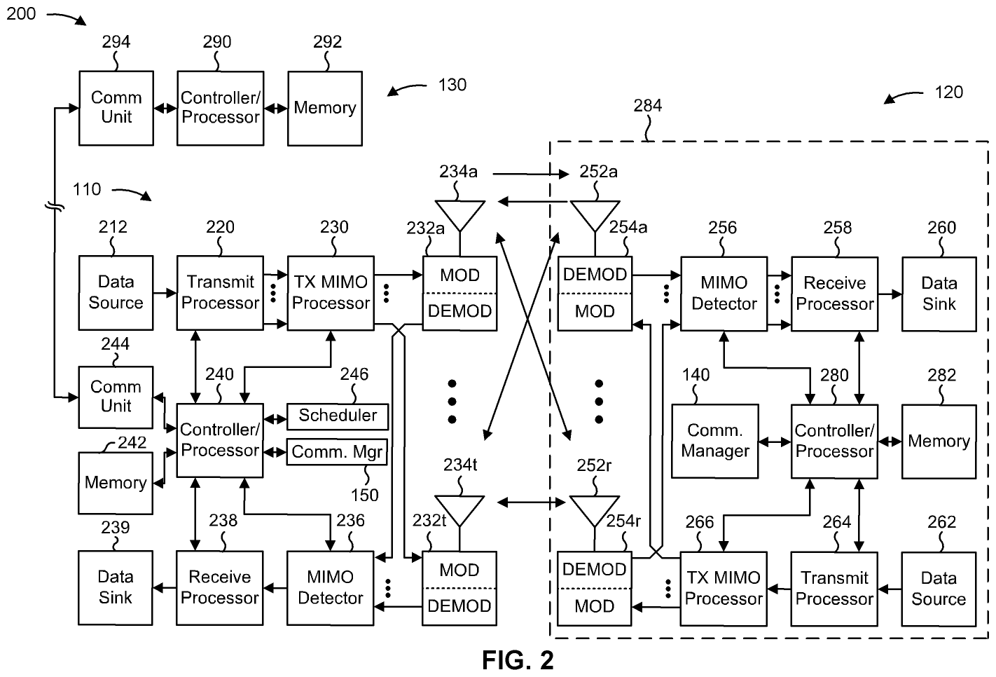

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

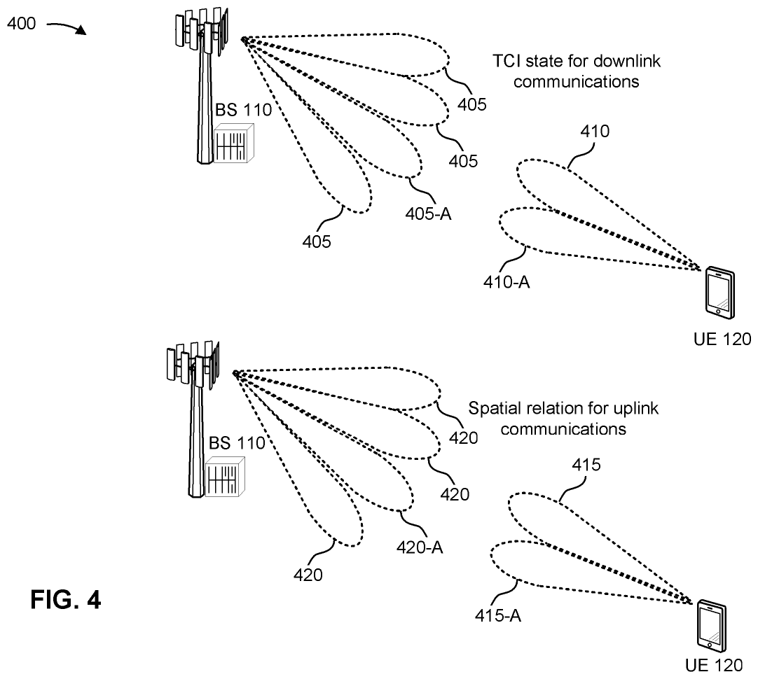

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-15).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-15).

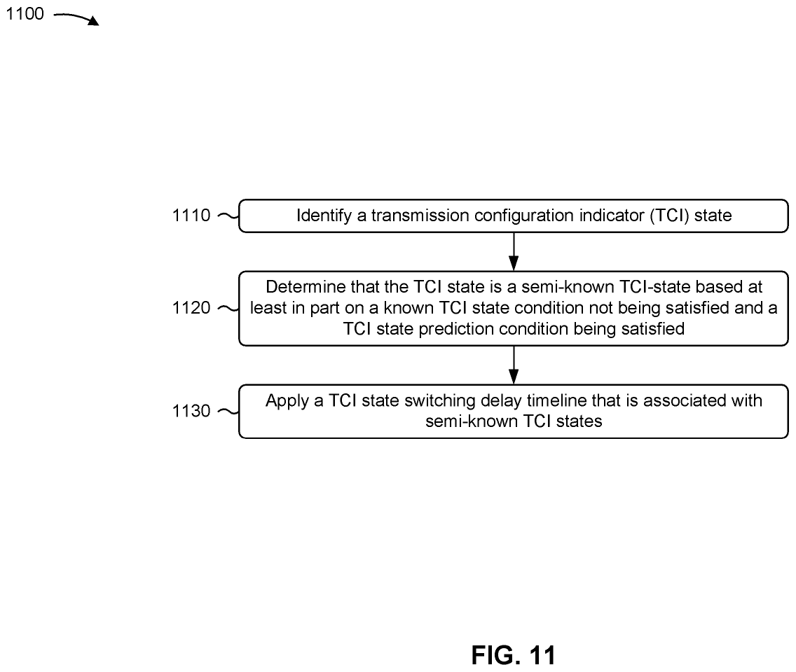

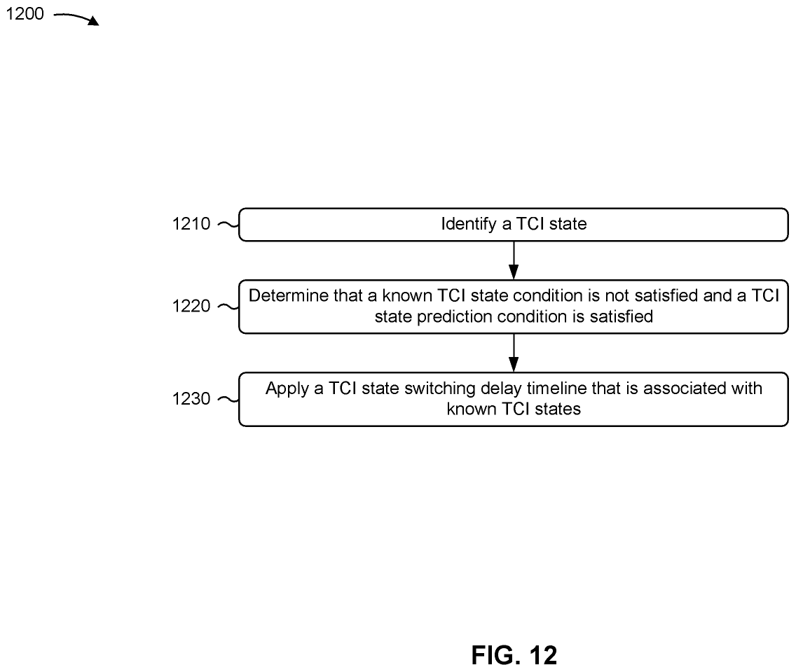

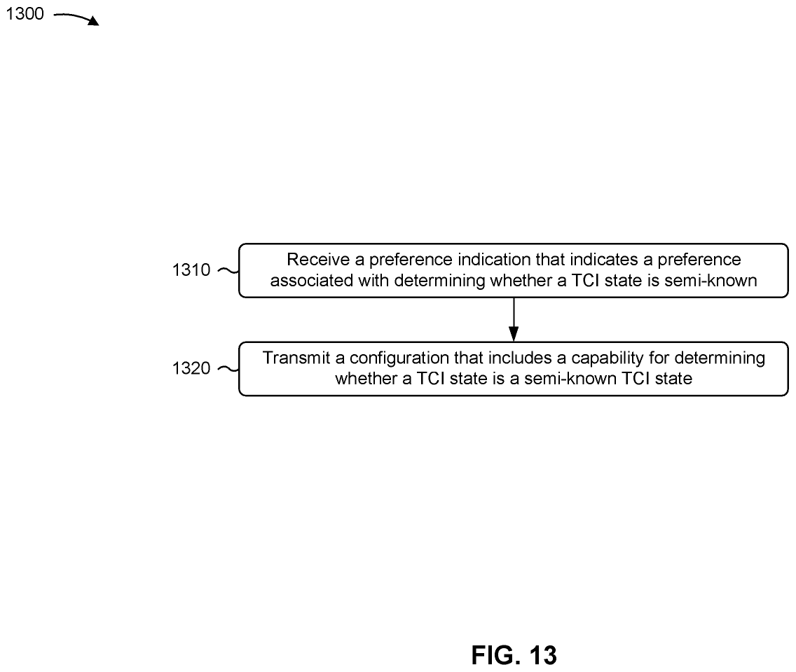

A controller/processor of a network entity (e.g., the controller/processor 240 of the base station 110), the controller/processor 280 of the UE 120, and/or any other component(s) of FIG. 2 may perform one or more techniques associated with using semi-known TCI states, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, process 1200 of FIG. 12, process 1300 of FIG. 13, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for identifying a TCI state; means for determining that the TCI state is a semi-known TCI-state based at least in part on a known TCI state condition not being satisfied and a TCI state prediction condition being satisfied; and/or means for applying a TCI state switching delay timeline that is associated with semi-known TCI states. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying a TCI state; means for determining that a known TCI state condition is not satisfied and a TCI state prediction condition is satisfied; and/or means for applying a TCI state switching delay timeline that is associated with known TCI states.

In some aspects, a network entity (e.g., a base station 110) includes means for receiving a preference indication that indicates a preference associated with determining whether a TCI state is semi-known; and/or means for transmitting a configuration that includes a capability for determining whether a TCI state is a semi-known TCI state. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

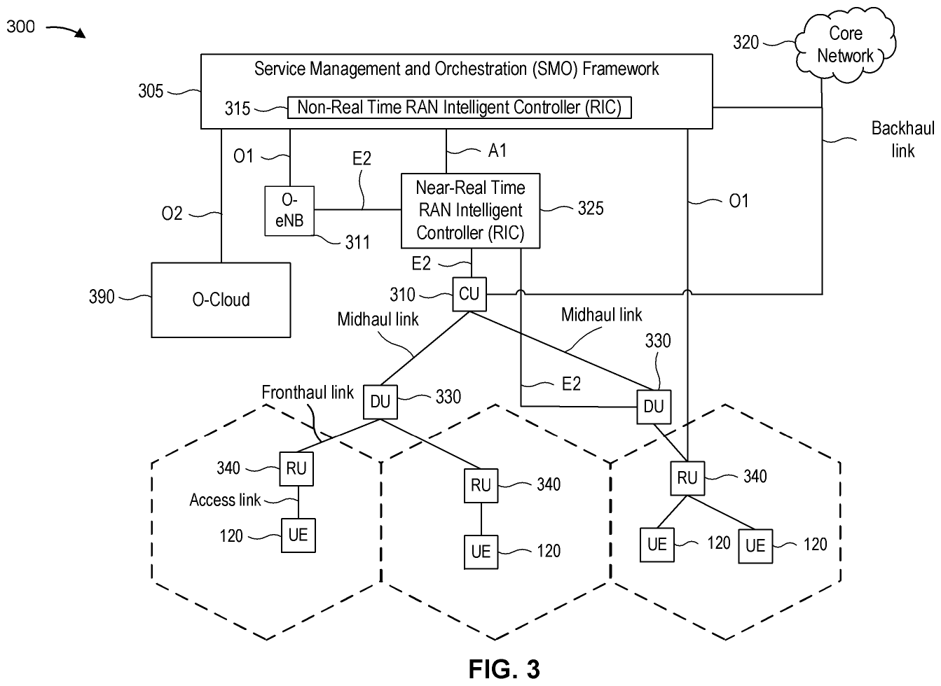

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUS (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of using beams for communications between a network entity and a UE, in accordance with the present disclosure. As shown in FIG. 4, a network entity (e.g., base station 110) and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a TCI state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each BS transmit beam 405 may be associated with a synchronization signal block (SSB), and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A, and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

As indicated above, FIG. 4 is provided as an example. Other examples may differ from what is described with regard to FIG. 4.

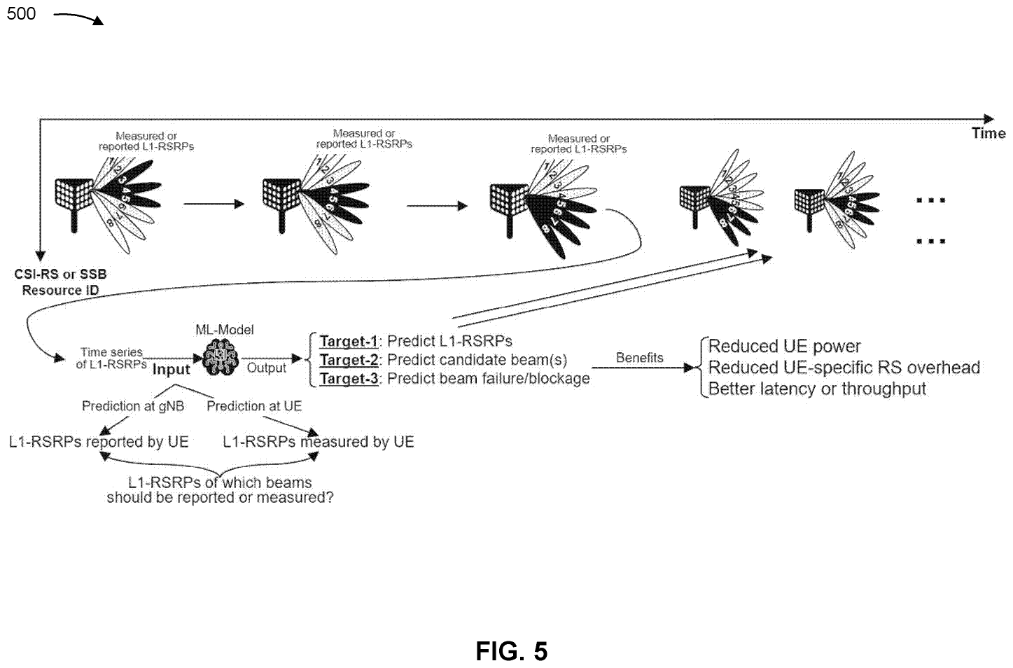

FIG. 5 is a diagram illustrating an example 500 of beam prediction, in accordance with the present disclosure.

Current beam management procedures need more power or overhead to achieve better performance, but restrictions on power or overhead limit beam accuracy. Predictive beam management in the time domain, the frequency domain, and the spatial domain can reduce power and overhead while increasing accuracy, latency, and throughput. However, the prediction of future transmit beams can depend on a UE's speed or trajectory, and the prediction of future receive beams may not successfully account for interference. It is difficult to predict future beams via conventional statistical methods.

Predictive beam management may involve AI/ML to improve beam selection accuracy and to address overhead, complexity, and latency issues. This may include using ML models to predict channel characteristics for beam prediction in the time domain and the spatial domain. Predictive beam management may also use ML models to predict non-measured beam qualities (for lower power/overhead or better accuracy) and/or to predict future beam blockage or failure (for less latency and higher throughput). Example 500 shows using Layer 1 (L1) RSRP measurements as inputs to an ML model for predicting L1-RSRPs, candidate beams, beam failures, or beam blockages. AI/ML helps with predictive beam management because beam prediction is a highly non-linear problem.

Beam prediction can be a tradeoff between performance and UE power. The UE has more observations (via measurements) than the network entity (via UE feedback) to predict future downlink transmit beam qualities. The UE may also outperform prediction at the network entity. However, this consumes more UE power. The training of ML models may help with data collection and computation at the UE. Data can be collected at an air interface and at higher layers. Model training may require UE computation, UE storage, and UE buffering.

As indicated above, FIG. 5 is provided as an example. Other examples may differ from what is described with respect to FIG. 5.

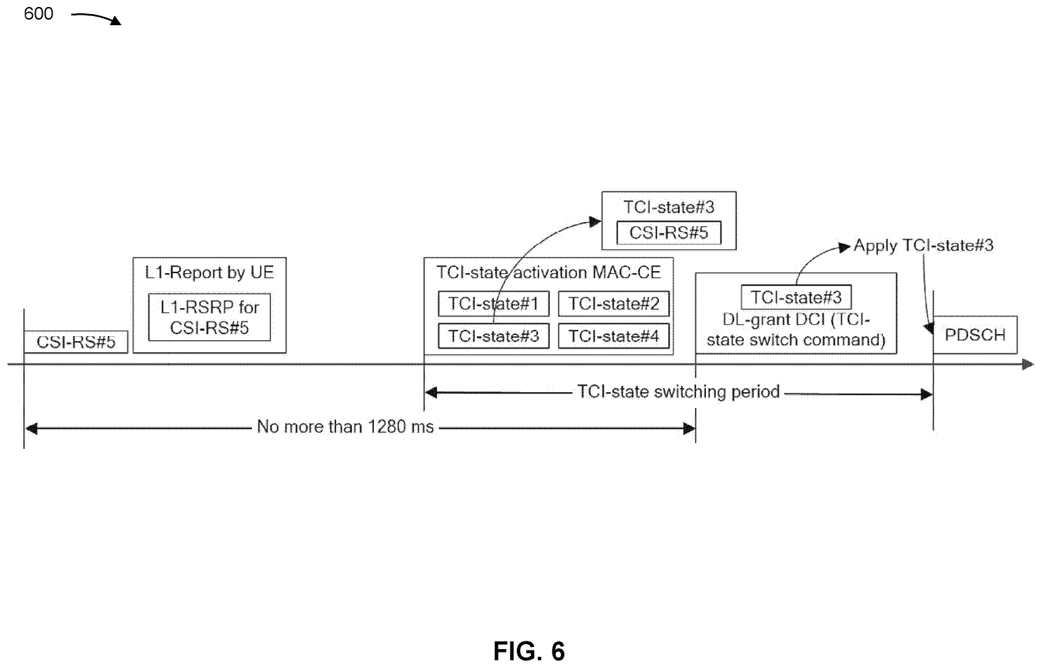

FIG. 6 is a diagram illustrating an example 600 of a known TCI state, in accordance with the present disclosure.

TCI state switching may involve known TCI states and unknown TCI states. A TCI state switching timeline may specify the delay between receiving a reference signal (RS) resource (e.g., CSI-RS, SSB) used for L1-RSRP measurement reporting for the target TCI state (activated TCI state) and completion of an active TCI state switch. The RS resource is the RS in the activated TCI state or QCLed to the activated TCI state. Example 600 shows that CSI-RS #5 is the RS and the activated TCI state to be applied to the TCI state switch is TCI-state #3.

The TCI state switching timeline for the TCI state switching period may depend on whether an activated TCI state is known or unknown. A TCI state is known if multiple conditions are met. This may include: (condition #1) if the TCI state switch command is received within 1280 milliseconds (ms) upon the last transmission of the RS resource for beam reporting or measurement; (condition #2) if the UE has transmitted at least 1 L1-RSRP report for the target TCI state before the TCI state switch command; (condition #3) if the TCI state remains detectable during the TCI state switching period (e.g., from the slot carrying the TCI state activation MAC CE to TCI switching completion); and (condition #4) if the SSB associated with the TCI state remains detectable during the TCI switching period. An RS may be detectable by the UE if the signal-to-noise ratio (SNR) for the RS is greater than or equal to 3 decibels (dB). This does not necessarily mean that there must be such an RS being transmitted. This might be verified by the UE via other RSs (e.g., DMRS). If these conditions are not met, the TCI state is unknown.

As indicated above, FIG. 6 is provided as an example. Other examples may differ from what is described with regard to FIG. 6.

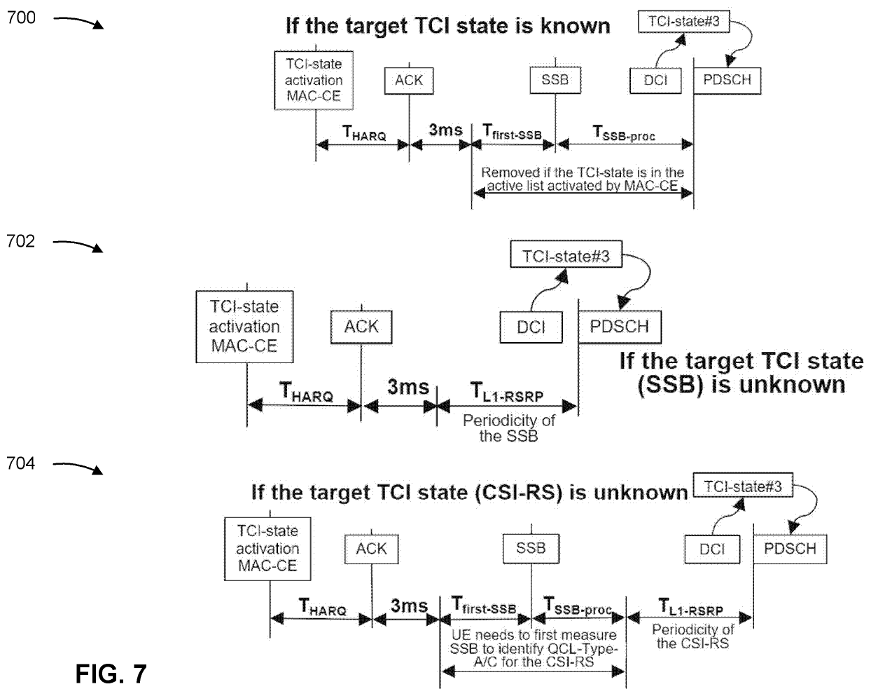

FIG. 7 is a diagram illustrating examples of TCI state switching timelines, in accordance with the present disclosure.

If the target TCI state (activated TCI state) is known (example 700), upon receiving a PDSCH communication carrying an MAC CE activation command in slot n, the UE may be able to receive the PDCCH communication with the target TCI state of the serving cell on the TCI state switch that occurs at the first slot that is after slot n+T_{HARQ}+(3 ms+TOₖ*(T_{first-SSB}+T_{SSB-proc}))/NR slot length. The UE may be able to receive the PDCCH communication with the old TCI state until slot n+T_{HARQ}+3 ms. T_{first-SSB} may be the time to the first SSB transmission after the MAC CE activation command is decoded by the UE. The SSB may be the QCL-TypeA or QCL-TypeC to the target TCI state. T_{SSB-proc} may be an SSB processing time of 2 ms. TOₖ may be 1 if the target TCI state is not in the active TCI state list for PDSCH, or 0 otherwise.

If the target TCI state is unknown (examples 702 and 704), upon receiving the PDSCH communication carrying the MAC CE activation command in slot n, the UE may be able to receive a PDCCH communication with the target TCI state of the serving cell on the TCI state switch that occurs at the first slot that is after slot n+T_{HARQ}+(3 ms+T_{L1-RSRP}+TOᵤₖ*(T_{first-SSB}+T_{SSB-proc}))/NR slot length. The UE may be able to receive the PDCCH communication with the old TCI state until slot n+T_{HARQ}+(3 ms+T_{L1-RSRP}+TOᵤₖ*T_{first-SSB})/NR slot length. T_{L1-RSRP} may be the time for L1-RSRP measurement for receive beam refinement in FR2, defined as periodicity of the SSB/CSI-RS with respect to the TCI state. The T_{L1-RSPR_Measurement_Period_SSB} for SSB and T_{L1-RSRP_Measurement_Period_CSI-RS} for CSI-RS may be specified. TOᵤₖ may be 1 for CSI-RS based L1-RSRP measurement, and 0 for SSB based L1-RSRP measurement when TCI state switching involves QCL-TypeD. TOᵤₖ may be 1 when TCI state switching involves other QCL types.

For T_{L1-RSRP} for FR2, T_{L1-RSRP}=T_{L1-RSPR_Measurement_Period_SSB} for SSB as specified in different configurations with the assumption of factor M=1, beam sweeping factor N=8, and T_{Report}=0. For a configuration for non-discontinuous reception (non-DRX), T_{L1-RSPR_Measurement_Period_SSB} may be the maximum (max) of T_{Report} and the ceiling value (ceil) of (M×P×N)×T_{SSB}. For the non-DRX configuration, it is assumed that the UE needs 8 SSB cycles to refine its transmit beam. For a configuration for DRX cycle≤320 ms, T_{L1-RSPR_Measurement_Period_SSB} may be the maximum of T_{Report} and the ceiling value of ((1.5×M×P×N)×max(T_{DRX}, T_{SSB})). For a configuration for DRX cycle>320 ms, T_{L1-RSPR_Measurement_Period_SSB} may be the ceiling value of ((1.5×M×P×N)×T_{DRX}). T_{SSB}=ssb-periodicityServingCell may be the periodicity of the SSB-Index configured for L1-RSRP measurement. T_{DRX} may be the DRX cycle length. T_{Report} may be a configured periodicity for reporting.

For T_{L1-RSRP} for FR2, T_{L1-RSRP}=T_{L1-RSPR_Measurement_Period_CSI-RS} for CSI-RS as specified in different configurations with the assumption of M=1 and T_{Report}=0. Higher layer parameter repetition may be set to on. For aperiodic CSI-RS, the quantity of resources in a resource set may be at least equal to MaxNumberRxBeam, which may be RRC configured per band and can vary from 2 to 8. N_{res_per_set} may be the quantity of CSI-RS resources within the considered CSI-RS resource set. For a configuration for non-DRX, T_{L1-RSPR_Measurement_Period_CSI-RS} may be the maximum (max) of T_{Report} and the ceiling value (ceil) of (M×P×N)×T_{CSI-RS}. For maxNumberRxBeam=N_{res_per_set}, the UE may be assumed to need one periodic or semi-periodic (P/SP) CSI-RS cycle to refine its receive beam. N may be ceil (maxNumberRxBeam/N_{res_per_set}) for P/SP-CSI-RS with repetition set to on. N may be 1 for AP CSI-RS assuming maxNumberRxBeam≤N_{res_per_set}. M may be 1 for P/SP CSI-RS. For a configuration for DRX cycle≤320 ms, T_{L1-RSPR_Measurement_Period_CSI-RS} may be the maximum of T_{Report} and the ceiling value of ((1.5×M×P×N)×max(T_{DRX}, T_{CSI-RS})). For a configuration for DRX cycle >320 ms, T_{L1-RSPR_Measurement_Period_CSI-RS} may be the ceiling value of ((M×P×N)×T_{DRX}). T_{CSI-RS} may be the periodicity of CSI-RS configured for L1-RSRP measurement. The requirements may be applicable provided that the CSI-RS resource configured for L1-RSRP measurement is transmitted with a density of 3.

As indicated above, FIG. 7 is provided as an example. Other examples may differ from what is described with regard to FIG. 7.

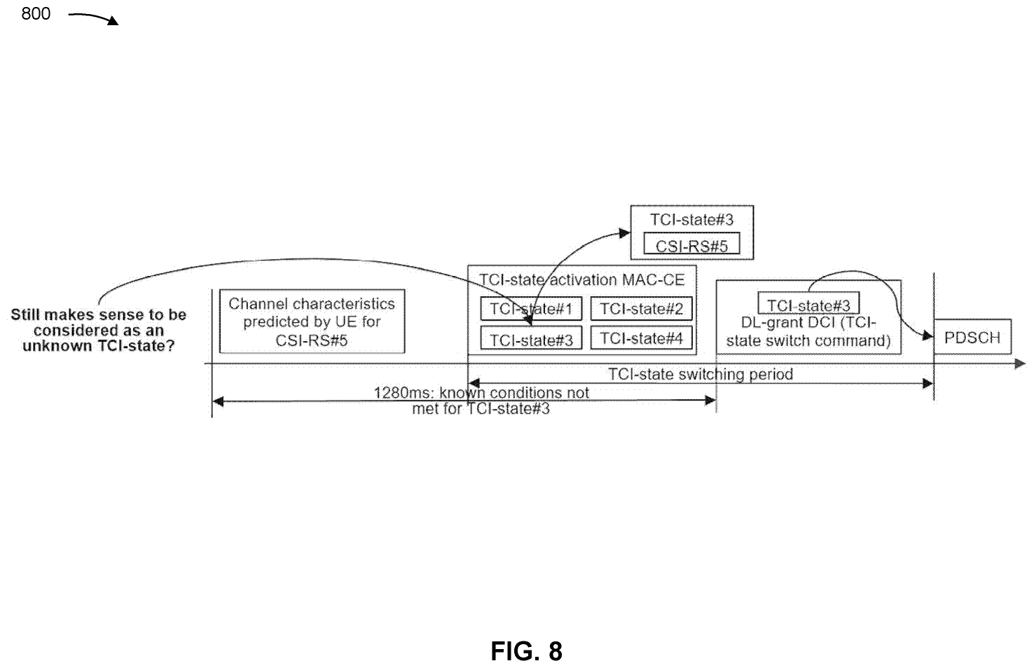

FIG. 8 is a diagram illustrating an example 800 of predicting channel characteristics, in accordance with the present disclosure.

As shown by example 800, the UE may have already predicted channel characteristics regarding a certain SSB or CSI-RS and a proper receive spatial filter (with respect to QCL-TypeA/C/D) related to such an SSB or CSI-RS, without actually measuring the SSB or CSI-RS. For example, for time domain beam prediction, the UE may predict future L1-RSRPs regarding SSBs, and optionally report the predicted L1-RSRPs without actually measuring them (against known TCI state condition #2). The UE may predict whether the strongest SSB is going to switch to another one for a future duration instead of a most recent L1 measurement report. If there is no change, the UE may simply do nothing. If a change is predicted, the UE may request an AP/SP L1-measurement report in an on-demand manner (against known TCI state condition #2). For spatial domain prediction, the UE may predict L1-RSRPs associated with CSI-RSs (e.g., with periodicity=2000 ms) based on SSBs (e.g., with periodicity=20 ms), without frequently measuring the CSI-RSs (against known TCI state condition #1). Such cases are considered to be unknown TCI-states, but some latencies are not necessary for such predictive beam management. For example, for SSB/CSI-RS, the UE may simply apply the predicted receive spatial filter, without measuring the SSB/CSI-RS. For CSI-RS, the UE may only need to measure the SSB again to verify QCL-TypeA/C, but there is no need to actually measure the CSI-RS.

In other words, while channel characteristics may be predicted, the TCI state may still be considered unknown under current known TCI state conditions. This can introduce more latency than is necessary.

As indicated above, FIG. 8 is provided as an example. Other examples may differ from what is described with regard to FIG. 8.

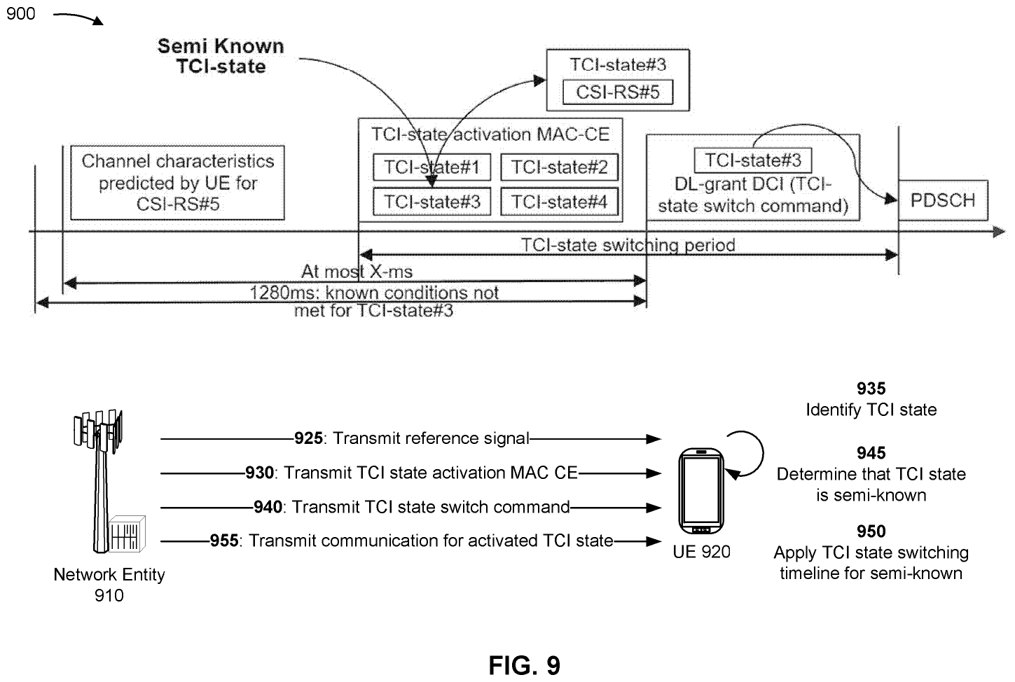

FIG. 9 is a diagram illustrating an example 900 of using a semi-known TCI state, in accordance with the present disclosure. As shown in FIG. 9, a network entity 910 (e.g., base station 110) and a UE 920 (e.g., a UE 120) may communicate with one another.

According to various aspects described herein, the UE may use a semi-known TCI state status with respect to CSI-RS/SSB channel characteristic prediction. The TCI state may be semi-known when channel characteristics do not meet a known TCI state condition but meet a prediction condition. As all known TCI state conditions are to be satisfied for a TCI state to be considered a known TCI state, not satisfying one of the TCI state conditions means that the TCI state is not known. The prediction condition may be met if channel characteristics are predicted within a prediction time duration. If an activated TCI state is semi-known, the UE may use a TCI state switching timeline that is specific to the semi-known status. In this way, the predicted channel characteristics may be used to reduce latency instead of faulting to the longer TCI state switching timeline for unknown TCI states. For example, the TCI state switching timeline for semi-known TCI states may remove the L1-Alternatively, the UE may fall back to the known TCI state status if a known TCI state condition is not met but the prediction condition is met.

Example 900 shows use of a semi-known TCI state (e.g., TCI state #3). As shown by reference number 925, the network entity 910 may transmit a reference signal (e.g., CSI-RS, SSB). As shown by reference number 930, the network entity 910 may transmit a TCI state activation command (e.g., MAC CE). As shown by reference number 935, the UE 920 may identify the TCI state. The UE 920 may identify the TCI state based at least in part on the TCI state activation command MAC CE that activates or updates the TCI state. The UE 920 may identify the TCI state from an earlier MAC CE. The UE 920 may identify the TCI state from among TCI states that are in an activated TCI state list. The UE 920 may identify the TCI state from among TCI states that are outside the activated TCI state list. As shown by reference number 940, the network entity 910 may transmit a TCI state switch command (e.g., downlink control information (DCI)).

As shown by reference number 945, the UE 920 may determine that the TCI state is semi-known. That is, the UE 920 may determine that known conditions are not met for TCI state #3. For example, the TCI state switch command may be received beyond 1280 ms after receiving the reference signal (e.g., CSI-RS #5) and the UE 920 has not transmitted a (convention) L1-RSRP report for the target TCI state before the TCI state switch command. However, a prediction condition is met. The UE 920 has predicted channel characteristics associated with the reference signal in the TCI state (or QCLed with the RS) within a prediction duration.

The predication duration may be configured to be X ms before receiving the TCI state switch command associated with the TCI state. The value of the prediction duration may be configured for a specific prediction scenario, and different values of the prediction duration may be used for different prediction scenarios. For example, one scenario (e.g., beam change prediction/report) may be more suitable for semi-static environments, such that the prediction duration is longer for this scenario than for other scenarios. The different values may be specified in a standard, configured by the network entity 910, or indicated by the network entity 910 via an RRC message, a MAC CE, or DCI. The UE 920 may also transmit a preferred value for the prediction duration.

In some aspects, the channel characteristics may include a predicted L1-RSRP that is reported without actually receiving the RS or measuring the RS. For example, the UE 920 may measure only SSBs (e.g., periodicity=20 ms) to identify or report L1-RSRPs of CSI-RSs (e.g., periodicity of 2000 ms). The channel characteristics may be based at least in part on transmitting a preference for using the RS resource as a Type D QCL source without transmitting an L1-RSRP report. For example, the UE 920 may only report an SSB resource indicator (SSBRI) as a preferred TypeD-QCL source without reporting its L1-RSRP. The channel characteristics may be based at least in part on the preference of using the reference signal as a TypeD-QCL source (without transmitting the preference). For example, the UE 920 may transmit an L1-RSRP report for SSB #3 comprising the strongest L1-RSRP at slot n, and the UE 920 may only request actual L1-RSRP reports if the UE 920 determines that the strongest SSB would change to another SSB. The UE 920 may indicate the preference of using the SSB #3 as TypeD-QCL source without actually reporting its L1-RSRP (which is agreed between the UE 920 and the network entity 910).

As shown by reference number 950, the UE 920 may apply the TCI state switching timeline for semi-known TCI states. The TCI state switching timeline may affect the delay or time between the slot in which the TCI state activation command (MAC-CE) is received and the first TCI state switch command (DCI) associated with the TCI-state. There may be priority rules between semi-known and unknown. If a TCI state can be considered to be semi-known at a certain time, the TCI state may not be considered to be unknown until the conditions for semi-known are no longer met.

The UE 920 and the network entity may apply the TCI state switch according to the TCI state switching timeline for semi-known TCI states. As shown by reference number 955, the network entity 910 may transmit a communication (e.g., on the PDSCH) using the activated TCI state. The UE 920 may receive the communication using the activated TCI state. By using a TVCI state switching timeline for semi-known states, latency may be reduced.

In some aspects, the UE 920 may indicate (applicability indication) whether the semi-known TCI states are applicable to the UE 920. For example, if the UE 920 identifies that a reference signal in the TCI state is applicable to semi-known conditions, the UE 920 may assume that the TCI state is applicable to semi-known states. That is, the UE 920 may determine that the TCI state is capable of being a semi-known TCI state without signaling from the network entity 910.

In some aspects, the UE 920 may determine that the TCI state is capable of being a semi-known TCI state based at least in part on signaling from the network entity 910. The network entity 910 may control the use of semi-known TCI states. The network entity 910 may indicate to UE 920 that a TCI state is applicable to semi-known states. For example, the network entity 910 may configure, via an RRC configuration for a TCI state or the TCI state activation command, whether semi-known states can be assumed or used by the UE 920 (can overwrite other RRC configurations for TCI state states). The network entity 910 may also configured the UE 920 using a MAC CE to dedicatedly activate the TCI states that can be applicable to semi-known states. The network entity 910 may indicate the TCI states activated by such a MAC CE in DCI (with corresponding dedicated radio network temporary identifiers (RNTIs) or DCI formats). For example, DCI may further indicate the indicated TCI state identifiers (IDs) that are related to types of TCI state activation commands.

In some aspects, the UE 920 may report whether a TCI state is applicable to semi-known states. The UE 920 may report a preference (preference indication) for which RRC configured TCI states can be assumed to be semi-known states. The UE 920 may report, together with an acknowledgement (ACK) regarding the TCI state activation MAC CE, UE reports for one or more of the TCI states activated by the MAC CE and whether semi-known states can be assumed. This can be further based on overwriting an MAC CE indication through such UE reporting. The UE 920 may report its preference on the value of X (e.g., different values of X for different scenarios).

As indicated above, FIG. 9 is provided as an example. Other examples may differ from what is described with respect to FIG. 9.

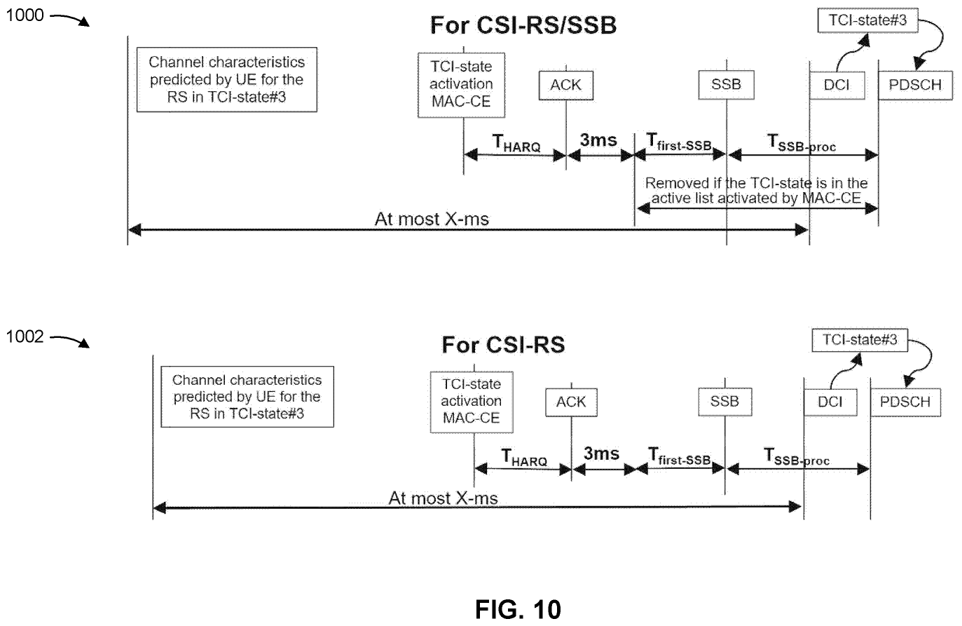

FIG. 10 is a diagram illustrating examples of TCI state switching timelines for semi-known TCI states, in accordance with the present disclosure.

The TCI state switching timeline for semi-known TCI states may be different than for unknown TCI states. Example 1000 shows a first option for a timeline that applies to both SSB and CSI-RS. No SSB or CSI-RS measurements need to be performed, after the slot receiving the TCI state activation command (MAC CE) and before the slot receiving the TCI state switch command (DCI) used to identify the semi-known TCI state. The UE 920 may have previously identified a proper QCL-TypeA/C for the TCI state. If the target TCI state that was included in the active TCI state list for the PDSCH communication is semi-known, the UE 920 may be able to receive a PDCCH communication with a target TCI state of the serving cell on the TCI state switch that occurs at the first slot that is after slot n+T_{HARQ}+(3 ms+TOₛₖ*(T_{first-SSB}+T_{SSB-proc}))/NR slot length, when TCI state switching involves TypeD-QCL. The UE 920 may be able to receive a PDCCH communication with the old TCI state until slot n+T_{HARQ}+3 ms/NR slot length. By using a semi-known state, the quantity of SSB cycles to refine a beam (beam sweep) may be reduced from 8 SSB cycles for an unknown TCI state to perhaps 2 or 3 SSB cycles for a semi-known TCI state. This saves overhead and reduces latency.

Example 1002 applied only for CSI-RS. The UE 920 does not need to perform measurements of the CSI-RS but still needs to perform measurements of the SSBs to identify QCL-TypeA/C for the target TCI-state, after the slot receiving the TCI state activation command (MAC CE) and before the slot receiving the TCI state switch command (DCI) identifying the semi-known TCI state. If the target TCI state that was included in the active TCI state list for the PDSCH communication is semi-known, the UE 920 may be able to receive the PDCCH communication with target TCI state of the serving cell on the TCI state switch that occurs at the first slot that is after slot n+T_{HARQ}+(3 ms+(T_{first-SSB}+T_{SSB-proc}))/NR slot length, when TCI-state switching involves TypeD-QCL. The UE 920 may be able to receive the PDCCH communication with the old TCI state until slot n+T_{HARQ}+ (3 ms+T_{first-SSB})/NR slot length. TO sk for semi-known states may be 0 if a TCI state is found in a TCI state list. The timeline may not include T_{L1-RSRP}. The UE 920 may identify QCL-TypeA/C if the TCI state is not in the list.

In some aspects, the TCI state switching timeline for semi-known states may include a dedicated time value of T_{L1_RSRP_SemiKnown}. The UE 920 may reuse a TCI state switching timeline for unknown TCI states but replace any T_{L1-RSRP} value with the T_{L1_RSRP_SemiKnown} for semi-known TCI states. For SSBs, the UE 920 receive beam sweeping factor N may be reduced based at least in part on a standard definition (e.g., N may be reduced to 2 or 3 as compared to 8 for unknown TCI-states), a network entity configuration (e.g., RRC preconfigures the value of N for semi-known TCI states), or a network entity indication (e.g., the network entity 910 indicates the value of N for unknown TCI states through the TCI state activation command (MAC-CE)). The UE 920 may report the value of N for unknown TCI states as its UE capability. For SSBs, the UE 920 may apply different receive beams on a PSS, an SSS, a first DMRS, and/or a second DMRS with respect to the same SSB for fast receive beam refinement.

For CSI-RSs, the UE 920 receive beam sweeping factor N may be reduced to ceil (maxNumberRxBeam/N_{res_per_set}/N_{SemiKnown}), where the value of N_{SemiKnown} may be identified further based at least in part on a standard definition (e.g., N_{Semiknown} is defined to be 2, N_{res_per_set} is defined as 2), a network entity configuration (e.g., RRC configures the value of N_{SemiKnown} for semi-known TCI states), and/or a network entity indication (e.g., the network entity 910 indicates the value of N_{SemiKnown} for unknown TCI states through the TCI state activation command (MAC-CE)). The UE 920 may report the value of N_{SemiKnown} for unknown TCI states as its UE capability. Different signaling may be used for different scenarios. By using a semi-known state, the quantity of CSI-RS cycles to refine a beam (beam sweep) may be reduced from 4 CSI-RS cycles (if ceil(maxNumberRxBeam/N_{res_per_set}=4) for an unknown TCI state to perhaps 2 CSI-RS cycles (if ceil (maxNumberRxBeam/N_{res_per_set}/N_{SemiKnown})=2) for a semi-known TCI state. This saves overhead and reduces latency.

As indicated above, FIG. 10 provides some examples. Other examples may differ from what is described with regard to FIG. 10.

FIG. 11 is a diagram illustrating an example process 1100 performed, for example, by a UE, in accordance with the present disclosure. Example process 1100 is an example where the UE (e.g., a UE 120, UE 920) performs operations associated with using semi-known TCI states.

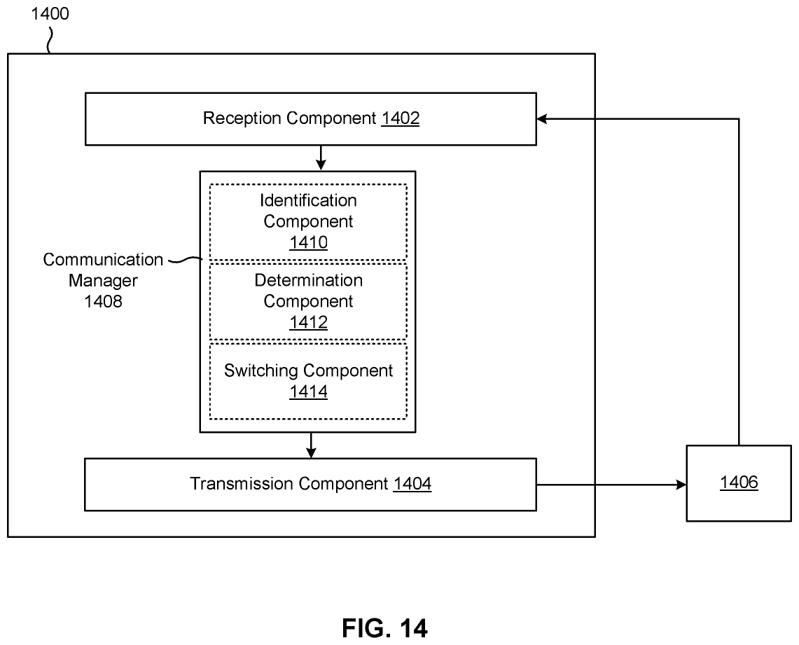

As shown in FIG. 11, in some aspects, process 1100 may include identifying a TCI state (block 1110). For example, the UE (e.g., using communication manager 1408 and/or identification component 1410, depicted in FIG. 14) may identify a TCI state, as described above.

As further shown in FIG. 11, in some aspects, process 1100 may include determining that the TCI state is a semi-known TCI-state based at least in part on a known TCI state condition not being satisfied and a TCI state prediction condition being satisfied (block 1120). For example, the UE (e.g., using communication manager 1408 and/or determination component 1412 depicted in FIG. 14) may determine that the TCI state is a semi-known TCI-state based at least in part on a known TCI state condition not being satisfied and a TCI state prediction condition being satisfied, as described above.

As further shown in FIG. 11, in some aspects, process 1100 may include applying a TCI state switching delay timeline that is associated with semi-known TCI states (block 1130). For example, the UE (e.g., using communication manager 1408 and/or switching component 1414 depicted in FIG. 14) may apply a TCI state switching delay timeline that is associated with semi-known TCI states, as described above.

Process 1100 may include additional aspects, such as any single aspect or any combination of aspects described below and/or in connection with one or more other processes described elsewhere herein.

In a first aspect, identifying the TCI state includes identifying the TCI state based at least in part on a MAC CE that activates or updates the TCI state.

In a second aspect, alone or in combination with the first aspect, identifying the TCI state includes identifying the TCI state from among TCI states that are in an activated TCI state list.

In a third aspect, alone or in combination with one or more of the first and second aspects, identifying the TCI state includes identifying the TCI state from among TCI states that are outside an activated TCI state list.

In a fourth aspect, alone or in combination with one or more of the first through third aspects, the known TCI state conditions include and are satisfied if a TCI state switch command is received within 1280 milliseconds after a last reference signal for beam reporting or measurement, at least one L1-RSRP report is transmitted for the TCI state before receiving the TCI state switch command, the TCI state remains detectable during a TCI state switching period, and an SSB associated with the TCI state remains detectable during the TCI state switching period.

In a fifth aspect, alone or in combination with one or more of the first through fourth aspects, the TCI state prediction condition is satisfied if channel characteristics for a reference signal resource are predicted within a prediction duration.

In a sixth aspect, alone or in combination with one or more of the first through fifth aspects, the channel characteristics that are predicted include L1-RSRP that is reported without receiving the RS or measuring the RS.

In a seventh aspect, alone or in combination with one or more of the first through sixth aspects, the channel characteristics are predicted based at least in part on transmitting a preference for using the RS resource as a Type D QCL source without transmitting an L1-RSRP report.

In an eighth aspect, alone or in combination with one or more of the first through seventh aspects, the channel characteristics are predicted based at least in part on a preference for using the RS resource as a Type D QCL source without transmitting an L1-RSRP report, and the preference is not transmitted.

In a ninth aspect, alone or in combination with one or more of the first through eighth aspects, the prediction duration is preconfigured for a specified prediction scenario.

In a tenth aspect, alone or in combination with one or more of the first through ninth aspects, process 1100 includes determining that the TCI state is capable of being a semi-known TCI state without signaling from a network entity.

In an eleventh aspect, alone or in combination with one or more of the first through tenth aspects, process 1100 includes determining that the TCI state is capable of being a semi-known TCI state based at least in part on signaling from a network entity.

In a twelfth aspect, alone or in combination with one or more of the first through eleventh aspects, the signaling includes an RRC message that indicates that the UE is able to determine whether the TCI state is capable of being a semi-known TCI state.

In a thirteenth aspect, alone or in combination with one or more of the first through twelfth aspects, the signaling includes a TCI state activation command.

In a fourteenth aspect, alone or in combination with one or more of the first through thirteenth aspects, the signaling includes a MAC CE message that is dedicated to activating TCI states and that is associated with semi-known TCI states.

In a fifteenth aspect, alone or in combination with one or more of the first through fourteenth aspects, process 1100 includes transmitting an applicability indication that indicates that the UE is applicable to using semi-known TCI states.

In a sixteenth aspect, alone or in combination with one or more of the first through fifteenth aspects, the applicability indication also indicates a preference for which TCI states are to be associated with a semi-known status.

In a seventeenth aspect, alone or in combination with one or more of the first through sixteenth aspects, process 1100 includes transmitting a preference indication of a preference for which TCI states are to be associated with a semi-known status.

In an eighteenth aspect, alone or in combination with one or more of the first through seventeenth aspects, process 1100 includes transmitting, in an acknowledgement of a TCI state activation command, an association indication that indicates whether a semi-known status is associated with the TCI state.

In a nineteenth aspect, alone or in combination with one or more of the first through eighteenth aspects, process 1100 includes transmitting a prediction duration indication of a preference for a prediction duration in which a prediction is to be made.

In a twentieth aspect, alone or in combination with one or more of the first through nineteenth aspects, the TCI state switching delay timeline associated with semi-known TCI states does not include a first delay for measuring a CSI-RS or an SSB and does not include a second delay for reporting an L1-RSRP measurement.

In a twenty-first aspect, alone or in combination with one or more of the first through twentieth aspects, the TCI state switching delay timeline associated with semi-known TCI states does not include a first delay for measuring a CSI-RS and does not include a second delay for reporting an L1-RSRP measurement.

In a twenty-second aspect, alone or in combination with one or more of the first through twenty-first aspects, the TCI state switching delay timeline includes a dedicated delay for L1 measurement reporting for semi-known TCI states.

In a twenty-third aspect, alone or in combination with one or more of the first through twenty-second aspects, process 1100 includes reducing a beam sweeping factor in response to the TCI state being a semi-known TCI state.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., a UE 120, UE 920) performs operations associated with falling back to a known TCI state.

As shown in FIG. 12, in some aspects, process 1200 may include identifying a TCI state (block 1210). For example, the UE (e.g., using communication manager 1408 and/or identification component 1410 depicted in FIG. 1410) may identify a TCI state, as described above.

As further shown in FIG. 12, in some aspects, process 1200 may include determining that a known TCI state condition is not satisfied and a TCI state prediction condition is satisfied (block 1220). For example, the UE (e.g., using communication manager 1408 and/or determination component 1412 depicted in FIG. 14) may determine that a known TCI state condition is not satisfied and a TCI state prediction condition is satisfied, as described above.

As further shown in FIG. 12, in some aspects, process 1200 may include applying a TCI state switching delay timeline that is associated with known TCI states (block 1230). For example, the UE (e.g., using communication manager 1408 and/or switching component 1414 depicted in FIG. 14) may apply a TCI state switching delay timeline that is associated with known TCI states, as described above.

Process 1200 may include additional aspects, such as any single aspect or any combination of aspects described below and/or in connection with one or more other processes described elsewhere herein.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110, network entity 910) performs operations associated with using semi-known TCI states.

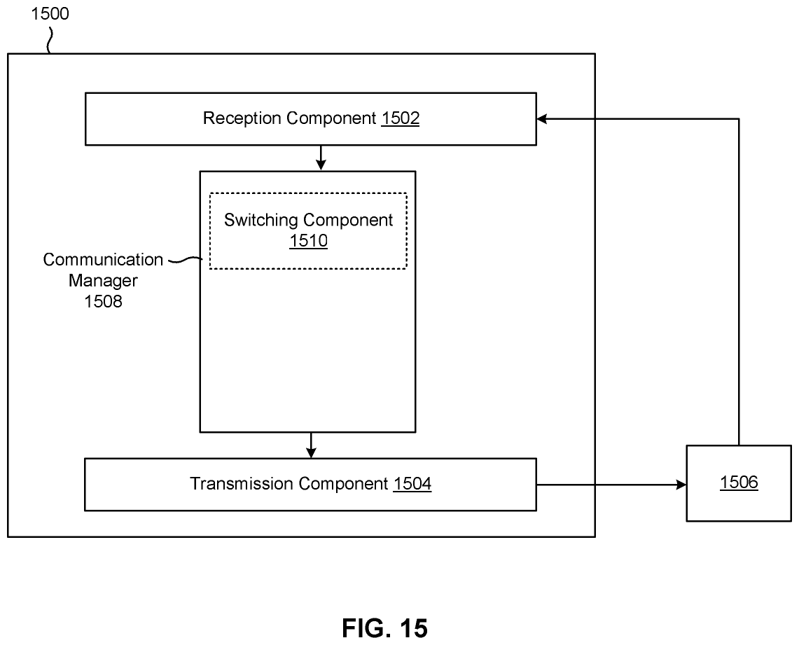

As shown in FIG. 13, in some aspects, process 1300 may include receiving a preference indication that indicates a preference associated with determining whether a TCI state is semi-known (block 1310). For example, the network entity (e.g., using communication manager 1508 and/or reception component 1502 depicted in FIG. 15) may receive a preference indication that indicates a preference associated with determining whether a TCI state is semi-known, as described above.

As further shown in FIG. 13, in some aspects, process 1300 may include transmitting a configuration that includes a capability for determining whether a TCI state is a semi-known TCI state (block 1320). For example, the network entity (e.g., using communication manager 1508 and/or transmission component 1504 depicted in FIG. 15) may transmit a configuration that includes a capability for determining whether a TCI state is a semi-known TCI state, as described above.

Process 1300 may include additional aspects, such as any single aspect or any combination of aspects described below and/or in connection with one or more other processes described elsewhere herein.

In a first aspect, receiving the preference indication includes receiving the preference indication in an acknowledgement of a TCI state activation command.

In a second aspect, alone or in combination with the first aspect, the preference indication includes a preference for a prediction duration in which a prediction is to be made.

In a third aspect, alone or in combination with one or more of the first and second aspects, process 1300 includes applying a TCI state switching delay timeline associated with semi-known TCI states.

In a fourth aspect, alone or in combination with one or more of the first through third aspects, the configuration reduces a beam sweeping factor for semi-known TCI states.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE (e.g., a UE 120, UE 920), or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 1408. The communication manager 1408 may control and/or otherwise manage one or more operations of the reception component 1402 and/or the transmission component 1404. In some aspects, the communication manager 1408 may include one or more antennas, a modem, a controller/processor, a memory, or a combination thereof, of the UE described in connection with FIG. 2. The communication manager 1408 may be, or be similar to, the communication manager 140 depicted in FIGS. 1 and 2. For example, in some aspects, the communication manager 1408 may be configured to perform one or more of the functions described as being performed by the communication manager 140. In some aspects, the communication manager 1408 may include the reception component 1402 and/or the transmission component 1404. The communication manager 1408 may include an identification component 1410, a determination component 1412, and/or a switching component 1414, among other examples.

In some aspects, the apparatus 1400 may be configured to perform one or more operations described herein in connection with FIGS. 1-10. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The identification component 1410 may identify a TCI state. The determination component 1412 may determine that the TCI state is a semi-known TCI-state based at least in part on a known TCI state condition not being satisfied and a TCI state prediction condition being satisfied. The switching component 1414 may apply a TCI state switching delay timeline that is associated with semi-known TCI states.

The determination component 1412 may determine that the TCI state is capable of being a semi-known TCI state without signaling from a network entity. The determination component 1412 may determine that the TCI state is capable of being a semi-known TCI state based at least in part on signaling from a network entity. The transmission component 1404 may transmit an applicability indication that indicates that the UE is applicable to using semi-known TCI states.

The transmission component 1404 may transmit a preference indication of a preference for which TCI states are to be associated with a semi-known status. The transmission component 1404 may transmit, in an acknowledgement of a TCI state activation command, an association indication that indicates whether a semi-known status is associated with the TCI state. The transmission component 1404 may transmit a prediction duration indication of a preference for a prediction duration in which a prediction is to be made. The switching component 1414 may reduce a beam sweeping factor in response to the TCI state being a semi-known TCI state.

In some aspects, the identification component 1410 may identify a TCI state. The determination component 1412 may determine that a known TCI state condition is not satisfied and a TCI state prediction condition is satisfied. The switching component 1414 may apply a TCI state switching delay timeline that is associated with known TCI states.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network entity (e.g., base station 110, network entity 910), or a network entity may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may control and/or otherwise manage one or more operations of the reception component 1502 and/or the transmission component 1504. In some aspects, the communication manager 1508 may include one or more antennas, a modem, a controller/processor, a memory, or a combination thereof, of the network entity described in connection with FIG. 2. The communication manager 1508 may be, or be similar to, the communication manager 150 depicted in FIGS. 1 and 2. For example, in some aspects, the communication manager 1508 may be configured to perform one or more of the functions described as being performed by the communication manager 150. In some aspects, the communication manager 1508 may include the reception component 1502 and/or the transmission component 1504. The communication manager 1508 may include a switching component 1510, among other examples.

In some aspects, the apparatus 1500 may be configured to perform one or more operations described herein in connection with FIGS. 1-10. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network entity described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network entity described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network entity described in connection with FIG. 2. In some aspects, the transmission component 1504 may be co-located with the reception component 1502 in a transceiver.

The reception component 1502 may receive a preference indication that indicates a preference associated with determining whether a TCI state is semi-known. The transmission component 1504 may transmit a configuration that includes a capability for determining whether a TCI state is a semi-known TCI state. The switching component 1510 may apply a TCI state switching delay timeline associated with semi-known TCI states.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a user equipment (UE), comprising: identifying a transmission configuration indicator (TCI) state; determining that the TCI state is a semi-known TCI-state based at least in part on a known TCI state condition not being satisfied and a TCI state prediction condition being satisfied; and applying a TCI state switching delay timeline that is associated with semi-known TCI states.
Aspect 2: The method of Aspect 1, wherein identifying the TCI state includes identifying the TCI state based at least in part on a medium access control control element (MAC CE) that activates or updates the TCI state.
Aspect 3: The method of Aspect 1 or 2, wherein identifying the TCI state includes identifying the TCI state from among TCI states that are in an activated TCI state list.
Aspect 4: The method of Aspect 1 or 2, wherein identifying the TCI state includes identifying the TCI state from among TCI states that are outside an activated TCI state list.
Aspect 5: The method of any of Aspects 1-4, wherein the known TCI state conditions include: a TCI state switch command is received within 1280 milliseconds after a last reference signal for beam reporting or measurement; at least one Layer 1 reference signal received power report is transmitted for the TCI state before receiving the TCI state switch command; the TCI state remains detectable during a TCI state switching period; and a synchronization signal block associated with the TCI state remains detectable during the TCI state switching period.
Aspect 6: The method of any of Aspects 1-5, wherein the TCI state prediction condition is satisfied if channel characteristics for a reference signal (RS) resource are predicted within a prediction duration.
Aspect 7: The method of Aspect 6, wherein the channel characteristics that are predicted include a Layer 1 RS received power that is reported without receiving the RS or measuring the RS.
Aspect 8: The method of Aspect 6, wherein the channel characteristics are predicted based at least in part on transmitting a preference for using the RS resource as a Type D quasi-co-location source without transmitting a Layer 1 RS received power report.
Aspect 9: The method of Aspect 6, wherein the channel characteristics are predicted based at least in part on a preference for using the RS resource as a Type D quasi-co-location source without transmitting a Layer 1 RS received power report, and wherein the preference is not transmitted.
Aspect 10: The method of Aspect 6, wherein the prediction duration is preconfigured for a specified prediction scenario.
Aspect 11: The method of any of Aspects 1-10, further comprising determining that the TCI state is capable of being a semi-known TCI state without signaling from a network entity.
Aspect 12: The method of any of Aspects 1-11, further comprising determining that the TCI state is capable of being a semi-known TCI state based at least in part on signaling from a network entity.
Aspect 13: The method of Aspect 12, wherein the signaling includes a radio resource configuration message that indicates that the UE is able to determine whether the TCI state is capable of being a semi-known TCI state.
Aspect 14: The method of Aspect 12, wherein the signaling includes a TCI state activation command.
Aspect 15: The method of Aspect 12, wherein the signaling includes a medium access control control element message that is dedicated to activating TCI states and that is associated with semi-known TCI states.
Aspect 16: The method of any of Aspects 1-15, further comprising transmitting an applicability indication that indicates that the UE is applicable to using semi-known TCI states.
Aspect 17: The method of Aspect 16, wherein the applicability indication also indicates a preference for which TCI states are to be associated with a semi-known status.
Aspect 18: The method of any of Aspects 1-17, further comprising transmitting a preference indication of a preference for which TCI states are to be associated with a semi-known status.
Aspect 19: The method of any of Aspects 1-18, further comprising transmitting, in an acknowledgement of a TCI state activation command, an association indication that indicates whether a semi-known status is associated with the TCI state.
Aspect 20: The method of any of Aspects 1-19, further comprising transmitting a prediction duration indication of a preference for a prediction duration in which a prediction is to be made.
Aspect 21: The method of any of Aspects 1-20, wherein the TCI state switching delay timeline associated with semi-known TCI states does not include a first delay for measuring a channel state information reference signal (RS) or a synchronization signal block and does not include a second delay for reporting a Layer 1 RS received power measurement.
Aspect 22: The method of any of Aspects 1-21, wherein the TCI state switching delay timeline associated with semi-known TCI states does not include a first delay for measuring a channel state information reference signal (RS) and does not include a second delay for reporting a Layer 1 RS received power measurement.
Aspect 23: The method of any of Aspects 1-22, wherein the TCI state switching delay timeline includes a dedicated delay for Layer 1 measurement reporting for semi-known TCI states.
Aspect 24: The method of Aspect 23, further comprising reducing a beam sweeping factor in response to the TCI state being a semi-known TCI state.
Aspect 25: A method of wireless communication performed by a user equipment (UE), comprising: identifying a transmission configuration indicator (TCI) state; determining that a known TCI state condition is not satisfied and a TCI state prediction condition is satisfied; and applying a TCI state switching delay timeline that is associated with known TCI states.
Aspect 26: A method of wireless communication performed by a network entity, comprising: receiving a preference indication that indicates a preference associated with determining whether a transmission configuration indicator (TCI) state is semi-known; and transmitting a configuration that includes a capability for determining whether a TCI state is a semi-known TCI state.
Aspect 27: The method of Aspect 26, wherein receiving the preference indication includes receiving the preference indication in an acknowledgement of a TCI state activation command.
Aspect 28: The method of Aspect 26 or 27, wherein the preference indication includes a preference for a prediction duration in which a prediction is to be made.
Aspect 29: The method of any of Aspects 26-28, further comprising applying a TCI state switching delay timeline associated with semi-known TCI states.
Aspect 30: The method of any of Aspects 26-29, wherein the configuration reduces a beam sweeping factor for semi-known TCI states.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
identify a transmission configuration indicator (TCI) state;
determine that the TCI state is a semi-known TCI-state based at least in part on a known TCI state condition not being satisfied and a TCI state prediction condition being satisfied; and
apply a TCI state switching delay timeline that is associated with semi-known TCI states.

2. The UE of claim 1, wherein the one or more processors, to identify the TCI state, are configured to identify the TCI state based at least in part on a medium access control control element (MAC CE) that activates or updates the TCI state.

3. The UE of claim 1, wherein the one or more processors, to identify the TCI state, are configured to identify the TCI state from among TCI states that are in an activated TCI state list.

4. The UE of claim 1, wherein the one or more processors, to identify the TCI state, are configured to identify the TCI state from among TCI states that are outside an activated TCI state list.

5. The UE of claim 1, wherein known TCI state conditions include:
a TCI state switch command is received within 1280 milliseconds after a last reference signal for beam reporting or measurement;
at least one Layer 1 reference signal received power report is transmitted for the TCI state before receiving the TCI state switch command;
the TCI state remains detectable during a TCI state switching period; and
a synchronization signal block associated with the TCI state remains detectable during the TCI state switching period.

6. The UE of claim 1, wherein the TCI state prediction condition is satisfied if channel characteristics for a reference signal (RS) resource are predicted within a prediction duration.

7. The UE of claim 6, wherein the channel characteristics that are predicted include a Layer 1 RS received power that is reported without receiving the RS or measuring the RS.

8. The UE of claim 6, wherein the channel characteristics are predicted based at least in part on transmitting a preference for using the RS resource as a Type D quasi-co-location source without transmitting a Layer 1 RS received power report.

9. The UE of claim 6, wherein the channel characteristics are predicted based at least in part on a preference for using the RS resource as a Type D quasi-co-location source without transmitting a Layer 1 RS received power report, and wherein the preference is not transmitted.

10. The UE of claim 6, wherein the prediction duration is preconfigured for a specified prediction scenario.

11. The UE of claim 1, wherein the one or more processors are configured to determine that the TCI state is capable of being a semi-known TCI state without signaling from a network entity.

12. The UE of claim 1, wherein the one or more processors are configured to determine that the TCI state is capable of being a semi-known TCI state based at least in part on signaling from a network entity.

13. The UE of claim 12, wherein the signaling includes a radio resource configuration message that indicates that the UE is able to determine whether the TCI state is capable of being a semi-known TCI state.

14. The UE of claim 12, wherein the signaling includes a TCI state activation command.

15. The UE of claim 12, wherein the signaling includes a medium access control control element message that is dedicated to activating TCI states and that is associated with semi-known TCI states.

16. The UE of claim 1, wherein the one or more processors are configured to transmit an applicability indication that indicates that the UE is applicable to using semi-known TCI states.

17. The UE of claim 16, wherein the applicability indication also indicates a preference for which TCI states are to be associated with a semi-known status.

18. The UE of claim 1, wherein the one or more processors are configured to transmit a preference indication of a preference for which TCI states are to be associated with a semi-known status.

19. The UE of claim 1, wherein the one or more processors are configured to transmit, in an acknowledgement of a TCI state activation command, an association indication that indicates whether a semi-known status is associated with the TCI state.

20. The UE of claim 1, wherein the one or more processors are configured to transmit a prediction duration indication of a preference for a prediction duration in which a prediction is to be made.

21. The UE of claim 1, wherein the TCI state switching delay timeline associated with semi-known TCI states does not include a first delay for measuring a channel state information reference signal (RS) or a synchronization signal block and does not include a second delay for reporting a Layer 1 RS received power measurement.

22. The UE of claim 1, wherein the TCI state switching delay timeline associated with semi-known TCI states does not include a first delay for measuring a channel state information reference signal (RS) and does not include a second delay for reporting a Layer 1 RS received power measurement.

23. The UE of claim 1, wherein the TCI state switching delay timeline includes a dedicated delay for Layer 1 measurement reporting for semi-known TCI states.

24. The UE of claim 23, wherein the one or more processors are configured to reduce a beam sweeping factor in response to the TCI state being a semi-known TCI state.

25. A user equipment (UE) for wireless communication, comprising:
a memory; and
one or more processors, coupled to the memory, configured to:
identify a transmission configuration indicator (TCI) state;
determine that a known TCI state condition is not satisfied and a TCI state prediction condition is satisfied; and
apply a TCI state switching delay timeline that is associated with known TCI states.

26. A network entity for wireless communication, comprising:
a memory; and
one or more processors, coupled to the memory, configured to:
receive a preference indication that indicates a preference associated with determining whether a transmission configuration indicator (TCI) state is semi-known; and
transmit a configuration that includes a capability for determining whether a TCI state is a semi-known TCI state.

27. The network entity of claim 26, wherein the one or more processors, to receive the preference indication, are configured to receive the preference indication in an acknowledgement of a TCI state activation command.

28. The network entity of claim 26, wherein the preference indication includes a preference for a prediction duration in which a prediction is to be made.

29. The network entity of claim 26, wherein the one or more processors are configured to apply a TCI state switching delay timeline associated with semi-known TCI states.

30. The network entity of claim 26, wherein the configuration reduces a beam sweeping factor for semi-known TCI states.
